(19) United States
(12) Patent Application Publication
(10) Pub. No.: US 2023/0156181 A1
(43) Pub. Date: May 18, 2023

(54) Methods and Apparatuses for a High-throughput Video Encoder or Decoder

(71) Applicant: MEDIATEK INC., Hsinchu City (TW)

(72) Inventors: Chun-Chia CHEN, Hsinchu City (TW); Chih-Wei HSU, Hsinchu City (TW); Tzu-Der CHUANG, Hsinchu City (TW); Ching-Yeh CHEN, Hsinchu City (TW); Yu-Wen HUANG, Hsinchu City (TW)

(21) Appl. No.: 17/685,812

(22) Filed: Mar. 3, 2022

Related U.S. Application Data
(60) Provisional application No. 63/280,178, filed on Nov. 17, 2021.

(51) Int. Cl. H04N 19/105; H04N 19/132; H04N 19/159; H04N 19/176; H04N 19/46

(52) U.S. Cl. CPC H04N 19/105; H04N 19/46; H04N 19/132; H04N 19/159; H04N 19/176

(57) ABSTRACT

A video coding method and apparatus include receiving input data associated with a current block, determining a coding mode for the current block by disabling Geometric Partitioning Mode (GPM) when a size of the current block is greater than or equal to a threshold size, and encoding or decoding the current block according to the determined coding mode. In a high-throughput video encoder performing Rate Distortion Optimization (RDO) by parallel Processing Elements (PEs), all or partial PEs receive search range reference samples in a broadcasting form. The parallel PEs test multiple coding modes on various partitioning for the current block, decide a block partitioning structure for dividing the current block into one or more coding blocks, and decide a coding mode for each of the coding blocks.

### CROSS REFERENCE TO RELATED APPLICATIONS

The present invention claims priority to U.S. Provisional Pat. Application Serial No. 63/280,178, filed on Nov. 17, 2021, entitled “New Memory Bandwidth Reduction Method/Architecture in Hardware Encoder”. The U.S. Provisional Pat. Application is hereby incorporated by reference in its entirety.

### FIELD OF THE INVENTION

The present invention relates to high-throughput video encoding or decoding methods. In particular, the present invention relates to high-throughput video encoding methods implemented in a rate distortion optimization stage of video encoding systems.

### BACKGROUND AND RELATED ART

The Versatile Video Coding (VVC) standard is the latest video coding standard developed by the Joint Collaborative Team on Video Coding (JCT-VC) group of video coding experts from ITU-T Study Group. The VVC standard relies on a block-based coding structure which divides each picture into multiple Coding Tree Units (CTUs). A CTU consists of an NxN block of luminance (luma) samples together with one or more corresponding blocks of chrominance (chroma) samples. For example, each 4:2:0 chroma subsampling CTU consists of one 128x128 luma Coding Tree Block (CTB) and two 64 ×64 chroma CTBs. Each CTB in a CTU is further recursively divided into one or more Coding Blocks (CBs) in a Coding Unit (CU) for encoding or decoding to adapt to various local characteristics. Flexible CU structures such as the Quad-Tree-Binary-Tree (QTBT) structure improve the coding performance compared to the Quad-Tree (QT) structure employed in the High-Efficiency Video Coding (HEVC) standard. FIG. 1 illustrates an example of splitting a CTB by the QTBT structure, where the CTB is adaptively partitioned according to a quad-tree structure, then each quad-tree leaf node is adaptively partitioned according to a binary-tree structure. Binary-tree leaf nodes are denoted as CBs for prediction and transform without further partitioning. In addition to binary-tree partitioning, ternary-tree partitioning may be selected after quad-tree partitioning to capture objects in the center of quad-tree leaf nodes. Horizontal ternary-tree partitioning splits a quad-tree leaf node into three partitions, each of the top and bottom partitions has one quarter of the size of the quad-tree leaf node and the middle partition has a half of the size of the quad-tree leaf node. Vertical ternary-tree partitioning splits a quad-tree leaf node into three partitions, each of the left and right partitions has one quarter of the size of the quad-tree leaf node and the middle partition has a half of the size of the quad-tree leaf node. In a flexible structure, a CTB is first partitioned according to a quad-tree structure, then quad-tree leaf nodes are further partitioned according to a sub-tree structure which contains both binary and ternary partitions. Sub-tree leaf nodes are denoted as CBs in this flexible structure.

The prediction decision in video encoding or decoding is made at the CU level, where each CU is coded by one or a combination of coding modes selected in a Rate Distortion Optimization (RDO) stage. After obtaining a residual signal generated by the prediction process, the residual signal belong to a CU is further transformed into transform coefficients for compact data representation, and these transform coefficients are quantized and conveyed to the decoder. Several coding tools or coding modes introduced in the VVC standard are briefly described in the following.

Merge mode with MVD (MMVD) For a CU coded by the Merge mode, implicitly derived motion information is directly used for prediction sample generation. Merge mode with Motion Vector Difference (MMVD) introduced in the VVC standard further refines a selected Merge candidate by signaling Motion Vector Difference (MVD) information. A MMVD flag is signaled right after a regular Merge flag to specify whether MMVD mode is used for a CU. MMVD information signaled in the bitstream includes an MMVD candidate flag, an index to specify motion magnitude, and an index for indication of motion direction. In the MMVD mode, one of the first two candidates in the Merge list is selected to be used as the MV basis. An MMVD candidate flag is signaled to specify which one of the first two Merge candidates is used. A distance index specifies motion magnitude information and indicate a pre-defined offset from a starting point. An offset is added to either a horizontal or vertical component of the starting MV. The relation of the distance index and the pre-defined offset is specified in Table 1.

TABLE 1

The relation of distance index and pre-defined offset

| | | | | | | | | |
|---|---|---|---|---|---|---|---|---|
| Distance index | 0 | 1 | 2 | 3 | 4 | 5 | 6 | 7 |
| Offset (in unit of luma samples) | ¼ | ½ | 1 | 2 | 4 | 8 | 16 | 32 |

A direction index represents a direction of the MVD relative to the starting point. The direction index indicates one of the four directions along the horizontal and vertical directions. It is noted that the meaning of MVD sign could be variant according to the information of starting MVs. For example, when the staring MV(s) is a uni-prediction MV or bi-prediction MVs with both lists pointing to the same direction of the current picture, the sign shown in Table 2 specifies the sign of the MV offset added to the starting MV. Both lists pointing to the same direction of the current picture if Picture Order Counts (POCs) of two reference pictures are both larger than the POC of the current picture, or POCs of two reference pictures are both smaller than the POC of the current picture. In cases when the starting MVs is bi-prediction MVs with two MVs pointing to different directions of the current picture and the difference of the POCs in list 0 is greater than the one in list 1, the sign in Table 2 specifies the sign of the MV offset added to the list 0 MV component of the starting MV and the sign for the list 1 MV has an opposite sign. Otherwise, when the difference of the POCs in list 1 is greater than the one in list 0, the sign in Table 2 specifies the sign of the MV offset added to the list 1 MV component of the starting MV and the sign for the list 0 MV has an opposite sign. The MVD is scaled according to the difference of POCs in each direction. If the differences of POCs in both lists are the same, no scaling is needed; otherwise, if the difference of POCs in list 0 is larger than the one of list 1, the MVD for list 1 is scaled, by defining the POC difference of List 0 as td and POC difference of List 1 as tb. If the POC difference of List 1 is greater than List 0, the MVD for list 0 is scaled in the same way. If the starting MV is uni-predicted, the MVD is added to the available MV.

TABLE 2

Sign of MV offset specified by direction index

| | | | | |
|---|---|---|---|---|
| Direction IDX | 00 | 01 | 10 | 11 |
| x-axis | + | — | N/A | N/A |
| y-axis | N/A | N/A | + | — |

Bi-prediction with CU-level Weight (BCW) A bi-prediction signal is generated by averaging two prediction signals obtained from two different reference pictures and/or using two different motion vectors in the HEVC standard. In the VVC standard, the bi-prediction mode is extended beyond simple averaging to allow weighted averaging of the two prediction signals.

$${P}_{\text{bi-pred}} = \left(\left(8 - w\right) ∗ {P}_{0} + w ∗ {P}_{1} + 4\right) ≫ 3.$$

In the VVC standard, five weights w ∈ {-2, 3, 4, 5, 10} are allowed in the weighted averaging bi-prediction. In each bi-predicted CU, the weight w is determined in one of two ways: 1) for a non-Merge CU, the weight index is signaled after the motion vector difference; 2) for a Merge CU, the weight index is inferred from neighboring blocks based on the Merge candidate index. BCW is only applied to CUs with 256 or more luma samples, which implies the CU width times the CU height must be greater than or equal to 256. For low-delay pictures, all 5 weights are used. For non-low-delay pictures, only 3 weights w∈{3,4,5} are used.

Fast search algorithms are applied to find the weight index without significantly increasing the encoder complexity at the video encoders. When BCW is combined with Adaptive Motion Vector Resolution (AMVR), unequal weights are only conditionally checked for 1-pel and 4-pel motion vector precisions if the current picture is a low-delay picture. When BCM is combined with the affine mode, affine Motion Estimation (ME) is performed for unequal weights only if the affine mode is selected as the current best mode. Unequal weights are only conditionally checked when the two reference pictures in bi-prediction are the same. Unequal weights are not searched when certain conditions are met, depending on the POC distance between the current picture and its reference pictures, the coding QP, and the temporal level.

The BCW weight index is coded using one context coded bin followed by bypass coded bins. The first context coded bin indicates if equal weight is used; and if unequal weight is used, additional bins are signaled using bypass coding to indicate which unequal weight is used. Weighted Prediction (WP) is a coding tool supported by the H.264/AVC and HEVC standards to efficiently code video content with fading. Support for WP was also added into the VVC standard. WP allows weighting parameters (weight and offset) to be signaled for each reference picture in each of the reference picture lists L0 and L1. The weight(s) and offset(s) of the corresponding reference picture(s) are applied during motion compensation. WP and BCW are designed for different types of video content. In order to avoid interactions between WP and BCW, which will complicate the VVC decoder design, if a CU uses WP, then the BCW weight index is not signaled, and w is inferred to be 4, implying equal weight is applied. For a Merge CU, the weight index is inferred from neighboring blocks based on the Merge candidate index. This can be applied to both normal Merge mode and inherited affine Merge mode. For constructed affined Merge mode, the affine motion information is constructed based on the motion information of up to 3 blocks. The BCW index for a CU using the constructed affine Merge mode is simply set equal to the BCW index of the first control point MV. In the VVC standard, Combined Inter and Intra Prediction (CIIP) and BCW cannot be jointly applied for a CU. When a CU is coded with the CIIP mode, the CBW index of the current CU is set to 4, implying equal weight is applied.

Geometric Partitioning Mode (GPM) In the VVC standard, GPM is supported for inter prediction. The use of GPM is signaled using a CU-level flag as one kind of Merge modes, with other Merge modes including regular Merge mode, MMVD mode, CCIP mode, and subblock Merge mode. In total, 64 partitions are supported by GPM for each possible CU size w × h = 2 ^{m} × 2ⁿ with m, n ∈ {3 ••• 6} excluding 8×64 and 64×8. Formerly, when this mode is used, a CU is split into two parts by a geometrically located straight line as shown in FIG. 2. The location of the splitting line is mathematically derived from an angle and offset parameters of a specific partition. Each part of a geometric partition in the CU is inter-predicted using its own motion information; only uni-prediction is allowed for each partition, that is, each part has one motion vector and one reference index. The uni-prediction motion constraint is applied to ensure that only two motion compensated predictors are computed for each CU, which is the same as the conventional bi-prediction.

If geometric partitioning mode is used for the current CU, then a geometric partition index indicating the partition mode of the geometric partition (angle and offset), and two Merge indices (one for each partition) are further signaled. The number of maximum GPM candidate size is signaled explicitly in the Sequence Parameter Set (SPS) and specifies syntax binarization for GPM merge indices. The sample values are adjusted using a blending processing with adaptive weights to acquire the prediction signal for the whole CU. Transform and quantization process will be applied to the whole CU as in other prediction modes. Finally, the motion field of a CU predicted using the geometric partition mode is stored.

The uni-prediction candidate list is derived directly from the Merge candidate list constructed according to the extended Merge prediction process. Denote n as the index of the uni-prediction motion in the geometric uni-prediction candidate list. The LX motion vector of the n-th extended Merge candidate, with X equal to the parity of n, is used as the n-th uni-prediction motion vector for geometric partitioning mode. For example, the uni-prediction motion vector for Merge index 0 is L0 MV, the uni-prediction motion vector for Merge index 1 is L1 MV, the uni-prediction motion vector for Merge index 2 is L0 MV, and the uni-prediction motion vector for Merge index 3 is L1 MV. In case a corresponding LX motion vector of the n-th extended Merge candidate does not exist, the L(1 - X) motion vector of the same candidate is used instead of the uni-prediction motion vector for geometric partitioning mode.

After predicting each part of a geometric partition using its own motion information, blending is applied to the two prediction signals to derive samples of the current CU. The blending weight for each position of the CU are derived based on the position of each sample and information about the partition mode of the geometric partition (for example, angle and offset) of the current CU.

A CU coded by GPM can include three parts, where a first part is inter-predicted based on a first set of predictors, a second part is inter-predicted based on a second set of predictors, and a third part between the first and second parts is inter-predicted based on a third set of predictors. The third set of predictors are derived by blending based on the first set of predictors and the second set of predictors. Mv1 from the first part of the geometric partition, Mv2 from the second part of the geometric partition and a combined motion vector of Mv1 and Mv2 are stored in the motion field of a geometric partitioning mode coded CU. The stored motion vector type for each individual position in the motion field is determined as:

$$\begin{matrix}s T y p e = a b s \left(m o t i o n I d x\right) < 32 ? 2 : \left(m o t i o n I d x \leq 0 ? \left(1 - p a r t I d x\right) :\right) \\ \left(p a r t I d x\right) 1\end{matrix}$$

where motionIdx is equal to d(4x + 2, 4y + 2), which is recalculated from the above equation. The partIdx depends on the angle index i. If sType is equal to 0 or 1, Mv0 or Mv1 are stored in the corresponding motion field, otherwise if sType is equal to 2, a combined motion vector from Mv0 and Mv2 are stored. The combined motion vector is generated using the following process: if Mv1 and Mv2 are from different reference picture lists (one from L0 and the other from L1), then Mv1 and Mv2 are simply combined to form bi-prediction motion vectors; otherwise, if Mv1 and Mv2 are from the same list, only the uni-prediction motion Mv2 is stored.

Combined Inter and Intra Prediction (CIIP) In the VVC standard, when a CU is coded in Merge mode, if the CU contains at least 64 luma samples (that is, CU width times CU height is equal to or larger than 64), and if both CU width and CU height are less than 128 luma samples, an additional flag is signaled to indicate whether Combined Inter and Intra Prediction (CIIP) mode is applied to the current CU. As the name suggested, CIIP mode combines an inter prediction signal with an intra prediction signal. The inter prediction signal in CIIP mode Pᵢₙₜₑᵣ is derived using the same inter prediction process applied to the regular Merge mode; and the intra prediction signal Pᵢₙₜᵣₐ is derived following the regular intra prediction process with the Planar mode. Then, the intra and inter prediction signals are combined using weighted averaging, where the weight value is calculated depending on the coding modes of the top and left neighbouring blocks as follows. A variable isIntraTop is set to 1 if the top neighboring block is available and intra coded, otherwise isIntraTop is set to 0, and a variable isIntraLeft is set to 1 if the left neighboring block is available and intra coded, otherwise isIntraLeft is set to 0. The weight value wt is set to 3 if the sum of the two variables isIntraTop and isIntraLeft is equal to 2, otherwise the weight value wt is set to 2 if the sum of the two variables is equal to 1; otherwise the weight value wt is set to 1. The CIIP prediction is calculated as follows:

$${P}_{\text{CIIP}} = \left(\left(4 - w t\right) ∗ {P}_{i n t e r} + w t ∗ {P}_{i n t r a} + 2\right) ≫ 2.$$

### BRIEF SUMMARY OF THE INVENTION

Embodiments of video coding methods for a video encoding system or video decoding system comprise receiving input data associated with a current block, comparing a size of the current block with a threshold size, determining a coding mode for the current block by disabling GPM when the size of the current block is greater than or equal to the threshold size, and encoding or decoding the current block by the determined coding mode. The current block includes a first part, a second part, and a third part when the coding mode is GPM, the first part of the current block is inter-predicted based on a first set of predictors while the second part of the current block is inter-predicted based on a second set of predictors, and the third part is inter-predicted based on a third set of predictors. The third set of predictors are derived by blending based on the first set of predictors and the second set of predictors. The current block in these embodiments is a Coding Block (CB) or a Coding Unit splitting from a Coding Tree Block (CTB) or Coding Tree Unit (CTU).

In some embodiments of the video encoding or decoding method, the threshold size is 2048 samples, and GPM is disabled for the current block when the size of the current block is 64×64, 64×32, or 32×64 samples. In some embodiment, GPM is enabled for large size blocks when a number of candidates in a Merge candidate list is small. For example, the video encoding or decoding system determines a number of candidates in a Merge candidate list of the current block, compares the number of candidates with a threshold number, and disables GPM for the current block when the number of candidates is larger than the threshold number. In this case, GPM is enabled for the current block when the size of the current block is smaller than the threshold size, or when the size of the current block is larger than or equal to the threshold size and the number of candidates in the Merge candidate list is less than or equal to the threshold number. An example of the threshold number is 3.

Embodiments of video encoding methods determine a block partitioning structure and coding modes using parallel Processing Elements (PEs). The video encoding methods comprise receiving an input data associated with a current block, processing the input data by the parallel PEs to determine the block partitioning structure of the current block and a corresponding coding mode for each coding block in the current block, and encoding each coding block in the current block according to the corresponding coding mode. Each PE performs tasks for a Rate Distortion Optimization (RDO) operation in each PE run. The PEs access a Search Range Memory (SRM) to fetch search range reference samples for the PEs. Two or more PEs receive search range reference samples in a broadcasting form. The PEs test a number of coding modes on possible partitions and sub-partitions of the current block, and based on rate-distortion costs associated with the coding modes tested by the PE groups, a block partitioning structure for splitting the current block into one or more coding blocks and a corresponding coding mode for each coding block are decided. The current block in these embodiments is a CTB or CTU, the coding blocks in the CTB are CBs and the coding blocks in the CTU are CUs.

In some embodiments of the present invention, the SRM is a 3-layer SRM structure including a layer 3 SRM, multiple layer 2 SRMs, and at least one broadcast SRM. The search range reference samples are output from the layer 3 SRM to the layer 2 SRM by time interleaving reading for distributing the search range reference samples to corresponding PEs. At least one layer 2 SRM outputs the search range reference samples to one broadcast SRM, and each broadcast SRM broadcasts the search range reference samples to two or more PEs at the same time. In one embodiment of the 3-layer SRM structure, a layer 3 cache port is shared by two or more layer 2 SRMs. A scanning order of each broadcast SRM is the same as a scanning order of the corresponding PEs in some preferred embodiments, so the broadcast SRM is a plug-in design.

The search range reference samples for a regular Merge candidate are broadcasted to PEs testing the regular Merge candidate, a GPM candidate, or a CIIP candidate according to embodiments of the present invention. Similarly, the search range reference samples for an Advanced Motion Vector Prediction (AMVP) candidate may be broadcasted to PEs testing the AMVP candidate or a Symmetric Motion Vector Difference (SMVD) candidate, or the search range reference samples for an Adaptive Motion Vector Resolution (AMVR) candidate may be broadcasted to PEs testing the AMVR candidate, a SMVD candidate, or a Bi-prediction with CU-level Weight (BCW) candidate. A scan order for the two or more PEs receiving the broadcasting search range reference samples is the same according to some embodiments of the present invention, thus the search range reference samples read out from the SRM are directly used by these PEs without buffering.

In some embodiments of the video encoding methods, the bandwidth between the SRM and the PEs may be further reduced by preloading search range reference samples of pre-loadable candidates. For example, the search range reference samples of pre-loadable candidates needed in a subsequent run are preloaded in a current run. Some examples of the pre-loadable candidates are AMVP candidates, AMVR candidates, and affine inter based candidates.

The coding modes tested by some of the PEs are reordered according to an embodiment so that high-bandwidth modes are processed in parallel with low-bandwidth modes. In an exemplary PE, a Merge mode with Motion Vector Difference (MMVD) candidate tested by one PE thread is reordered to be executed in parallel with an intra mode tested by another PE.

In one embodiment, at least one PE processing small coding blocks loads the search range reference samples of candidates from the SRM at the same time when the search range reference samples are in a same window or when a rotated-index is in a same window. In another embodiment, a bilinear filter is used in a Low Complexity (LC) operation for testing one or more MMVD candidates in order to reduce a reference region of the search range reference samples needed

Aspects of the disclosure further provide an apparatus for a video encoding or decoding system. The apparatus comprising one or more electronic circuits configured for receiving input data associated with a current block, checking if a size of the current coding block is greater than or equal to a threshold size, determining a coding mode for the current coding block by disabling GPM if a size of the current coding block is greater than or equal to the threshold size, and encoding or decoding the current block by the determined coding mode.

### BRIEF DESCRIPTION OF THE DRAWINGS

Various embodiments of this disclosure that are proposed as examples will be described in detail with reference to the following figures, wherein like numerals reference like elements, and wherein:

FIG. 1 illustrates an example of splitting a CTB by a QTBT structure.

FIG. 2 illustrates examples of GPM partitioning grouped by identical angles.

FIG. 3 illustrates a high throughput video encoder employing parallel PEs in each PE group.

FIG. 4 illustrates a new Search Range Memory (SRM) design for a high throughput video encoder according to an embodiment of the present invention.

FIG. 5 illustrates broadcasting search range reference samples for Merge based candidates to multiple PEs and broadcasting search range reference samples for Advanced Motion Vector Prediction (AMVP) based candidates to multiple PEs according to some embodiments of the present invention.

FIGS. 6A-6C illustrate reducing the port number needed for 24 parallel PEs by search range memory broadcasting and preloading techniques according to embodiments of the present invention.

FIG. 7 is a flowchart of encoding a current block by parallel PEs in a high-throughput video encoder according to an embodiment of the present invention.

FIG. 8 is a flowchart of determining whether GPM is enabled for a current block according to an embodiment of the present invention.

FIG. 9A illustrates an embodiment of reordering the coding modes to reduce the SRAM bandwidth; and FIG. 9B illustrates another embodiment of reordering the coding modes to reduce the SRAM bandwidth.

FIG. 10A illustrates an example of SRAM bandwidth wasted for PEs processing small partitions; and FIG. 10B illustrates an example of parallel loading multiple motion compensation reference regions according to an embodiment of the present invention.

FIG. 11 illustrates an embodiment of reducing the MMVD LC bandwidth by a bilinear filter.

FIG. 12 illustrates an exemplary system block diagram for a video encoding system incorporating one or a combination of the video encoding methods according to embodiments of the present invention.

FIG. 13 illustrates an exemplary system block diagram for a video decoding system incorporating one or a combination of the video decoding methods according to embodiments of the present invention

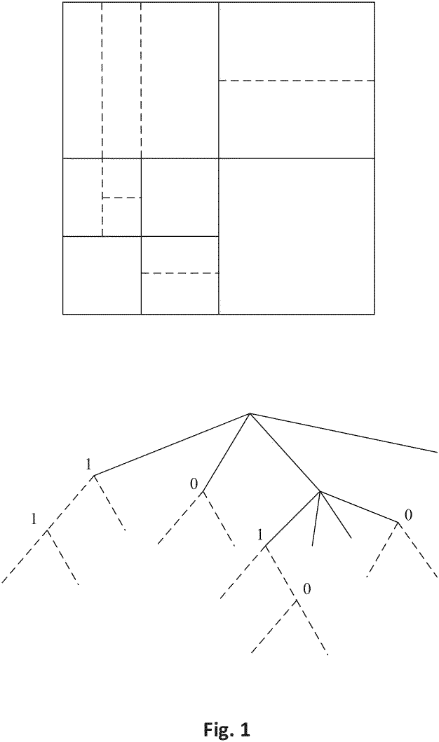

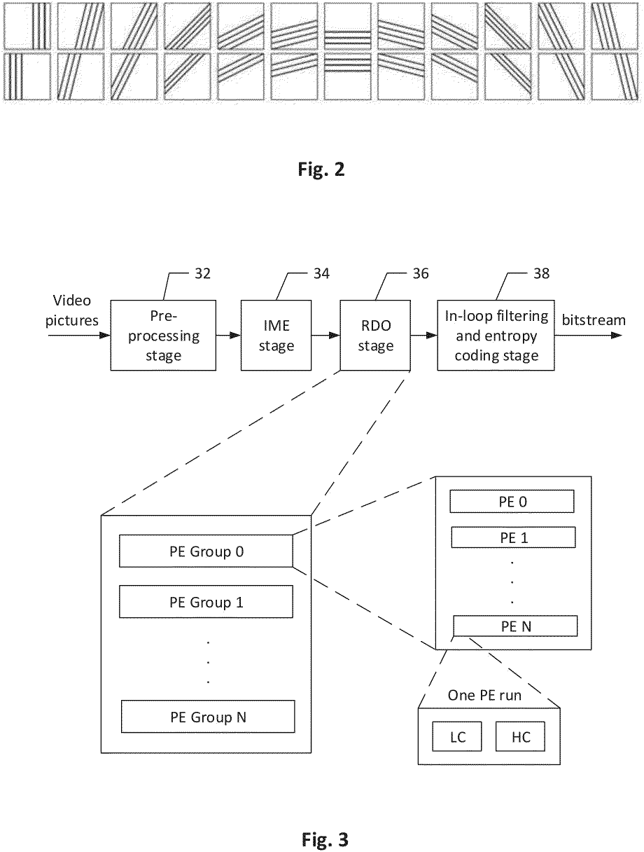

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “an embodiment”, “some embodiments”, or similar language means that a particular feature, structure, or characteristic described in connection with the embodiments may be included in at least one embodiment of the present invention. Thus, appearances of the phrases “in an embodiment” or “in some embodiments” in various places throughout this specification are not necessarily all referring to the same embodiment, these embodiments can be implemented individually or in conjunction with one or more other embodiments. Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

High Throughput Video Encoder A high throughput video encoder 300 for encoding video pictures into a video bitstream is illustrated in FIG. 3. The encoding processing of the high throughput video encoder 300 can be divided into four stages: a pre-processing stage 32, an Integer Motion Estimation (IME) stage 34, a Rate-Distortion Optimization (RDO) stage 36, and an in-loop filtering and entropy coding stage 38. Blocks in video pictures are sequentially processed in these stages. A common motion estimation architecture consists of Integer Motion Estimation (IME) and Fraction Motion Estimation (FME), where IME performs integer pixel search over a large area and FME performs sub-pixel search around the best selected integer pixel. In the RDO stage 36, multiple Processing Element (PE) groups each containing parallel PEs are used to determine a block partitioning structure for splitting a current block into one or more coding blocks and these PE groups are also used to determine a corresponding coding mode for each coding block. A PE is a generic term used to reference a hardware element that executes a stream of instructions to perform arithmetic and logic operations on data. Each PE executes tasks associated with a coding mode or one or more candidates of a coding mode in one or more PE runs. An example of the current block is a CTB and the coding blocks are CBs split from the CTB. The video encoder splits the current block into one or more coding blocks according to the block partitioning structure and encodes each coding block according to the coding mode decided by the RDO stage 36. In the RDO stage 36, each PE group has multiple parallel PEs and each PE performs tasks associated with a coding mode for a RDO operation in one or more PE runs. Each PE group sequentially computes a rate-distortion cost of coding modes applied on one or more partitions each having a particular block size and sub-partitions added up to the particular block size. For each PE group, a current block is divided into one or more partitions each having the particular block size associated with the PE group and each partition is divided into sub-partitions according to one or more partitioning types. Some exemplary partitioning types for dividing each partition into sub-partitions are horizontal binary-tree partitioning and vertical binary-tree partitioning. For example, the partition and sub-partitions for PE group 0 include the 128×128 partition, top 128×64 sub-partition, bottom 128×64 sub-partition, left 64×128 sub-partition, and 128×64 sub-partition. PEs in each PE group test various coding modes on each partition of the current block having the particular block size and corresponding sub-partitions split from each partition. A best block partitioning structure for the current block and best coding modes for the coding blocks are consequently decided according to rate-distortion costs associated with the tested coding modes in the RDO stage 36. A PE computes video data of a partition or sub-partition by a Low-Complexity (LC) Rate Distortion Optimization (RDO) operation followed by a High-Complexity (HC) RDO operation in each PE run.

Novel SRM Design for High-throughput Video Encoder The terms PE run or port run are used to count the number of time intervals required by a PE to test one or more coding modes. For example, a PE encodes a predetermined partition by an intra mode in one PE run. A bottleneck arose in Search Range Memory (SRM) accessing for high-throughput encoders is the high bandwidth required by the parallel PEs. The more parallel PEs employed in the video encoder the better the throughput, however, this implies enormous amount of parallel PEs are accessing the SRM simultaneously. Two possible solutions for reducing the high bandwidth requirement between the SRM and the PEs include installing N times copies of SRM and time-interleaving reading. The major drawback of having N times copies of SRM is the encoder cost will largely increase. Time-interleaving reading for a large number of PEs results in enormous reading-path buffers and long idle time. For example, when there are 64 PEs accessing the SRM through 64 ports at the same time, 720 SRM banks per resolution are required, resulting a total of 2880 separate SRAMs is required for testing the four resolutions in Adaptive Motion Vector Resolution (AMVR). For PEs processing less calculations, there will be a long idle time due to time-interleaving reading delay. Moreover, to preserve around 60 cycles of data for time-interleaving reading, the cost of reading buffers is extremely high. For example, the size of the reading buffer needed for one PE is 60 cycles *12 * 4 pixels * 10 bits/pixel = 28800 bits, which is also very costly.

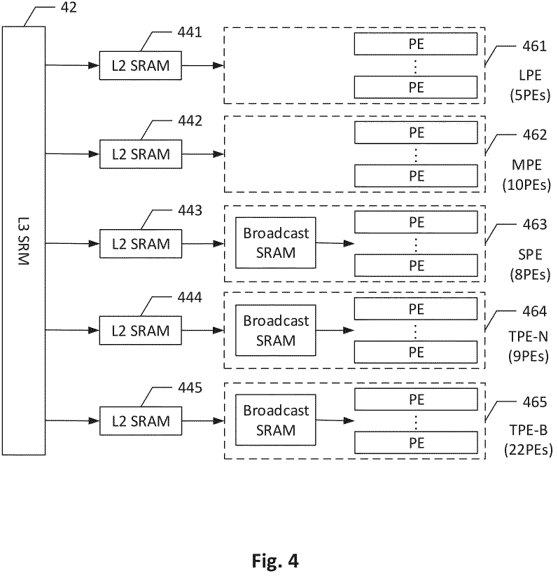

FIG. 4 illustrates an exemplary 3-layer SRM architecture for outputting data to 64 parallel PEs. Search range reference samples are output from Layer 3 SRM 42 to five Layer 2 SRMs 441-445 by time-interleaved reading. Each of the layer 2 SRMs 441-445 provides search range reference samples to one of the five PE groups Large PE (LPE) 461, Median PE (MPE) 462, Small PE (SPE) 463, first Tiny PE (TPE-N) 464, and second Tiny PE (TPE-B) 465. The five PE groups process difference sizes of block partitions. For example, the PE group LPE 461 processes 64×64 partitions and corresponding sub-partitions, and the PE group MPE 462 processes 32×32 partitions and corresponding sub-partitions. As shown in the example of FIG. 4, the PE group LPE 461 is consisting of 5 PEs, the PE group MPE 462 is consisting of 10 PEs, the PE group SPE 463 is consisting of 18 PEs, the PE group TPE-N 464 is consisting of 9 PEs, and the PE group TPE-B 465 is consisting of 22 PEs. The search range reference samples in Layer 2 SRMs are preloaded and distributed to PEs of the corresponding PE group. Each of the 5 PEs in the PE group LPE 461 accesses Layer 2 SRM 441 by a time-interleaving form, and each of the 10 PEs in the PE group MPE 462 accesses Layer 2 SRM 442 by a time-interleaving form. For each of Layer 2 SRMs 443, 444, and 445, a broadcast SRM is used for broadcasting search range reference samples to some of the PEs simultaneously. The layer 3 cache port in Layer 2 SRMs 444 can be reused by Layer 2 SRM 445. Broadcasting of search range reference samples to multiple PEs is beneficial as many related modes may reuse the search range reference samples of some fundamental modes. For example, encoding a current partition or sub-partition with GPM can reuse the search range reference samples of regular Merge modes, and encoding a current partition or sub-partition with MMVD can reuse the search range reference samples of Merge 0 and Merge 1. Encoding a current partition or sub-partition with Symmetric Motion Vector Difference (SMVD) can reuse the search range reference samples of AMVR. The search range reference samples for a coding mode or a candidate of a coding mode may be referred to as a reference range in the following. The number of ports can be reduced by implementing this 3-layer SRM architecture because Layer 3 SRM encounters port runs for the fundamental modes such as regular Merge mode and AMVR, and some PEs processing related modes can reuse the data. For PEs responsible for modes required less calculations, the idle rate will not largely increase by increasing the number of PEs to trade the throughput. The common used candidates are stored for multiple PEs as candidate-wise manner in order to reduce the number of access ports. Table 1 below shows an example of reducing the number of port runs required for performing various coding modes by implementing the 3-layer SRM architecture according to an embodiment of the present invention. In some embodiments, the reference region for all resolutions is constrained to be the same for AMVR in order to reduce the number of port runs required for AMVR. Some coding gain of AMVR may be lost due to sharing the same reference region for all resolutions but only 4 port runs are needed instead of 13 port runs. The original bandwidth needed by GPM can be saved as the reference ranges for each GPM pair reuse the reference ranges of two regular Merge candidates. Similarly, the reference range for each CIIP pair reuses the reference range of a corresponding regular Merge candidate.

TABLE 1

| Coding Tool | Required Reference Range | Original Number of Port-runs Needed | Number of Port-runs Under Local Cache |
|---|---|---|---|
| AMVR (four resolutions Q, H, 1, 4) | 4(Q), 4(H), 4(1), 4(4) | 4+3+3+3 | 4 |
| Regular Merge | 6 (cands)*2 (L0, L1) | 6 | 6 |
| Affine Inter | Case 1: 4 (4 para), 4 (6 para) | 8 | 2 |
| Affine Merge | 5 (cands)*2 (L0, L1) | 5 | 5 |
| sbTMVP | 2 (L0, L1) | 1 | 1 |
| GPM | 5 (cands)*2 (part 1, part 2) | 10 (PEcalls) | 0 (reuse Merge’s reference range) |
| CIIP | 6 (cands)*2 (L0,L1) | 6 | 0 (reuse Merge’s reference range) |
| MMVD | 2 | 8 | 2 |
| BCW | | 8+4+4+4 | 0 (reuse AMVR’s reference range) |
| SMVD | 9 | 3+3+3 | 2+2+2 (combine mirrored-ref) |

For blocks to be encoded in the affine Inter mode, the number of port runs can be reduced from 8 to 2 by forcing all pre-call of affine Inter candidates to use four shared reference regions. For PEs processing blocks to be encoded by the MMVD mode, the number of port runs can be reduced from 8 to 2 because 2 MMVD candidates reuse the reference regions of 2 Merge mode candidates with an enlarged range. The MMVD coding modes share some of the PEs originally perform tasks for the Merge mode. The number of port runs is greatly reduced by implementing the SRM architecture with local caches and storing common used candidates as candidate-wise manner.

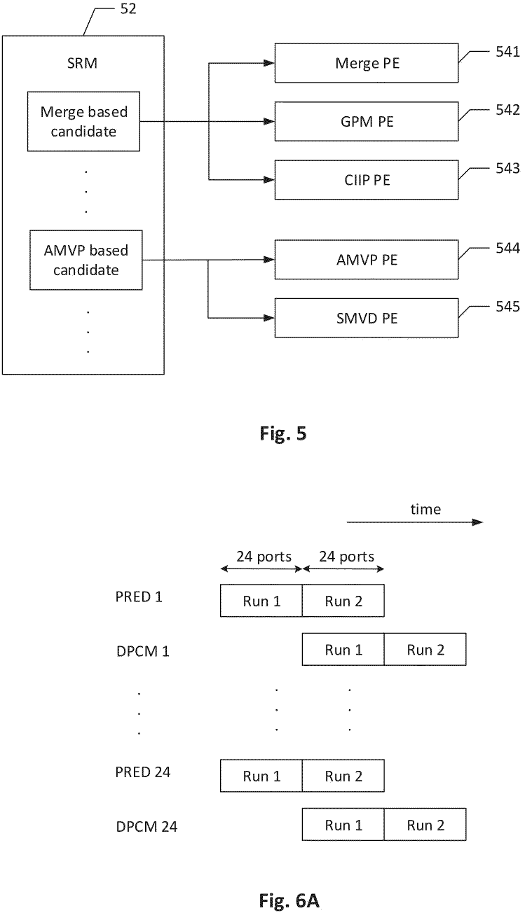

FIG. 5 illustrates broadcasting based accessing of SRM by multiple parallel processing PEs according to an embodiment of the present invention. All or partial PEs fetch search range reference samples from the SRM 52 in a broadcasting form. For example, PEs for executing Merge modes 541, PEs for executing GPM modes 542, and PEs for executing CIIP modes 543 fetch broadcasting search range reference samples for Merge-based candidates from SRM 521. Similarly, PEs for executing Advanced Motion Vector Prediction (AMVP) modes 544 and PEs for executing Symmetric Motion Vector Difference (SMVD) modes 545 fetch search range reference samples for AMVP-based candidates from SRM 522 in a broadcasting form. The access patterns of all PEs acquiring search range reference samples of the same candidate by broadcasting are all the same. In this way, the SRAM-readout data can be directly broadcasted by hard-wiring to all PEs without any arbitration. Candidates related to the coding tools such as GPM and CIIP are grouped into Merge candidates to reuse the SRAM bandwidth for the Merge candidates, and candidates related to the coding tools such as SMVD are grouped into AMVP candidates and reuse the SRAM bandwidth for the AMVP candidates. By implementing the broadcasting based SRM architecture, additional SRAM bandwidth is no longer required for processing GPM, CIIP, and SMVD candidates.

In some embodiments, the broadcasting based SRM architecture of the present invention is employed together with hardware sharing in parallel PEs for certain coding tools. In one embodiment, the candidate list for GPM is derived directly from the Merge candidate list, for example, six GPM candidates are derived from Merge candidates 0 and 1, Merge candidates 1 and 2, Merge candidates 0 and 2, Merge candidates 3 and 4, Merge candidates 4 and 5, and Merge candidates 3 and 5 respectively. After obtaining corresponding Merge prediction samples for each part of the geometric partition according to two Merge candidates, the Merge prediction samples around the geometric partition edge are blended to derive GPM prediction samples. With the hardware sharing in parallel PE design, an embodiment of a GPM PE shares the Merge prediction samples from one or more Merge PEs directly without temporary storing the Merge prediction samples in a buffer. A benefit of this parallel PE design with hardware sharing is to save the bandwidth, this benefit is achieved because GPM PEs directly use the Merge prediction samples from Merge PEs to do GPM arithmetic calculations instead of fetching reference samples from the buffer. By combining the broadcasting based SRM architecture and the hardware sharing in parallel PEs, the search range reference samples of Merge candidates for GPM candidates are retrieved from the broadcasting SRM, and the predictors of Merge candidates for GPM candidate are shared directly from the Merge PEs.

In some preferred embodiments, the scan order for all PEs sharing search range reference samples is the same, in that case, the search range reference samples read out from the SRM are directly used by the PEs without buffering. The access patterns of all PEs related to the same candidates by broadcasting are all the same, so the broadcasting based SRM architecture directly broadcasts the SRAM readout data by hard-wiring to all PEs without any arbitration. The temporary buffers between PEs and cache may be minimized. In an embodiment of the present invention, the broadcasting SRMs for the PE groups can be a plug-in design when the same scanning order is employed in the broadcast caches and the PE engines. In other words, the broadcasting based SRM architecture is a transparent accessing design for the PE engines to read search range reference samples from the SRM or write reference samples into the SRM when the scanning order of broadcast caches is equal to the PE access order. All or partial PEs can fetch reference samples in a broadcasting form as soon as these reference samples are available in the level 1 SRMs (i.e. the broadcast SRAMs as shown in FIG. 4). The benefits of such transparent accessing design include the plug-in flexibility for different scalability versions, and accessing between PEs and level 2/level 3 cache or between level 1 cache and level 2/level 3 cache is unified.

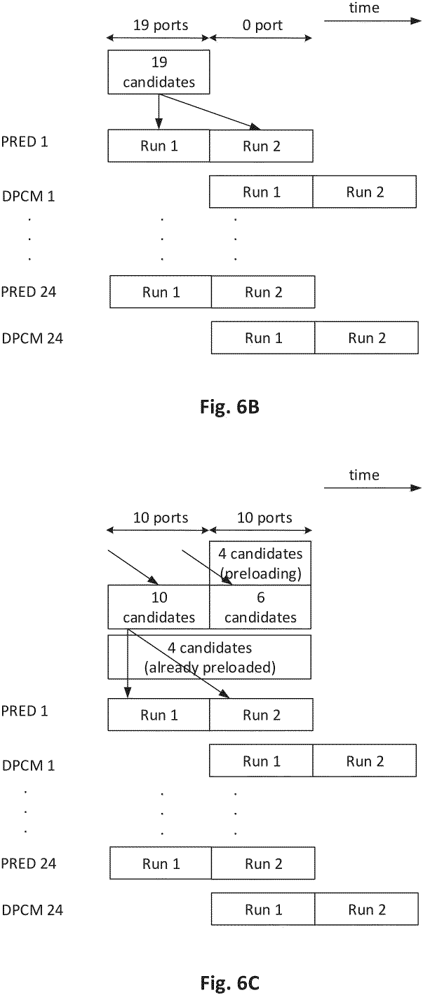

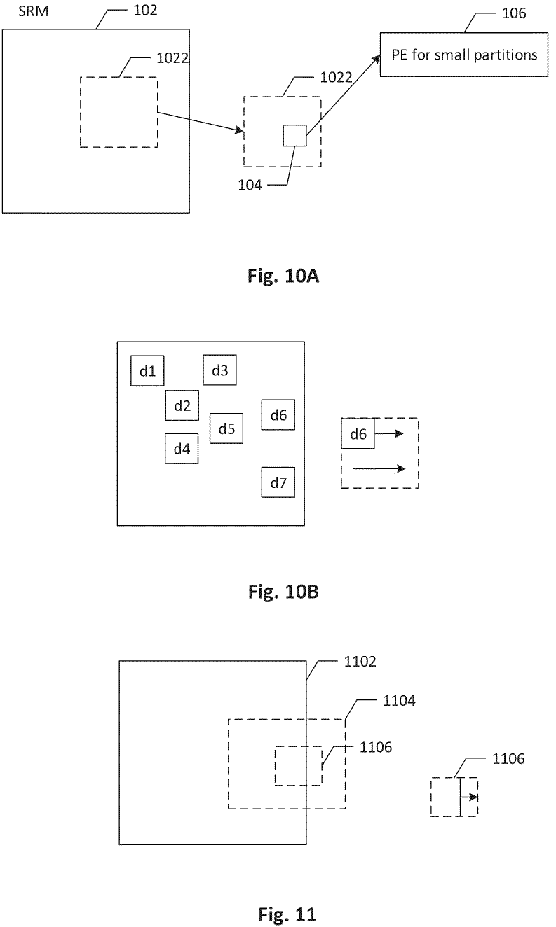

Further Improvement on SRM Design by Preloading Some embodiments of the present invention further improves the broadcasting based SRM design by more evenly distribute the loading time in each PE run. FIGS. 6A-6C demonstrate some examples of video encoding by 24 parallel PEs for MVRM-3 in PE group TPE-B. FIG. 6A illustrates 24 ports are needed for fetching search range reference samples in each run when broadcasting SRMs are not employed. FIG. 6B illustrates an embodiment of loading search range reference samples through broadcasting SRMs. Instead of occupying 24 ports in each run, 19 ports are needed in run 1 while none of the ports are needed in run 2 when broadcasting SRM is employed. Even though the number of ports for run 1 plus run 2 is significantly reduced, the loading bandwidth is very imbalanced as it requires 19 ports for run 1 and 0 port for run 2. FIG. 6C illustrates an embodiment of evenly distributing the loading time by using a preloading technique. Some candidates such as AMVP, AMVR, and affine Inter based candidates are pre-loadable because everything is already known in the IME stage. Some other candidates such as Merge based candidates must co-start with the current CU as it needs spatial neighboring information. As shown in FIGS. 6C, 10 candidates for a current partition such as Merge based candidates are loaded in run 1 of the low complexity RDO stage (PRED1-PRED24), while 4 candidates such as AMVR, AMVP, or affine Inter based candidates for the current partition are already preloaded from a previous run. In run 2 of the low complexity RDO stage, another 6 candidates for the current partition are loaded plus 4 candidates for a subsequent partition are preloaded. As a result of implementing the preloading technique, only 10 ports are needed in each run.

In the conventional design, N PEs access the SRM in a time-interleaving manner, where each PE needs to wait for N cycles to access the SRAM, thus a large internal buffer (regFile) is needed for each PE to buffer N cycle data. In comparison to the conventional design, the benefits of employing broadcasting based caches for all or partial PEs include eliminating or reducing the waiting time of PEs for accessing the SRM, eliminating or reducing the idle time of PEs processing short tasks, and eliminating the need of a large internal buffer for all or partial PEs. By further using the partial-preloading technique, the worse-case port-number can be reduced, so as to minimize the reference cache (refCache) worst-case bandwidth.

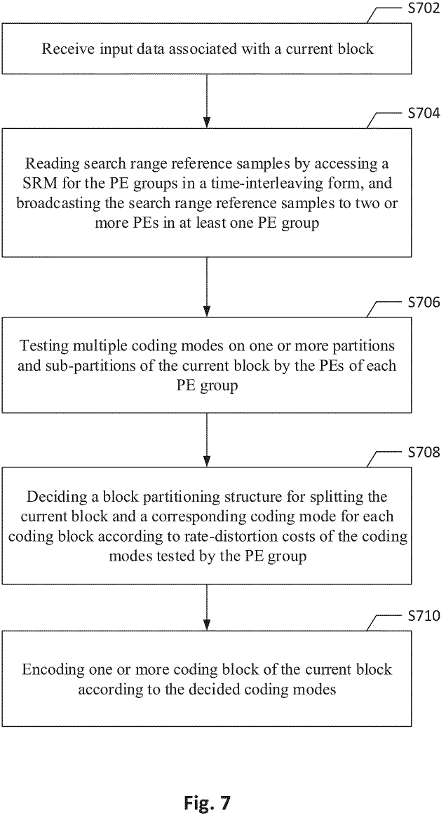

Representative Flowchart for SRM Accessing in High-throughput Video Encoder FIG. 7 is a flowchart illustrating an embodiment of determining a block partitioning structure and coding modes for a current block by parallel PE groups. In step S702, the parallel PE groups in the video encoding system receive input data of a current block, for example the current block is a CTU or a CTB. Each of the parallel PE groups reads search range reference samples by accessing a SRM one after another in a time-interleaving form in step S704. Two or more PEs in at least one PE group receive the search range reference samples by a broadcasting form. For example, search range reference samples of a Merge based candidate are broadcasted to PEs testing Merge, GPM, or CIIP modes. The PEs in each PE group test various coding modes on one or more partitions and sub-partitions in step S706. In step S708, a block partitioning structure for splitting the current block into one or more coding blocks and a corresponding coding mode for each coding block are decided according to rate-distortion costs of the coding modes tested by the PE groups. The video encoding system encodes the coding block(s) in the current block according to the corresponding coding mode(s) in step S710.

Adaptively Disable GPM In some embodiments of the present invention, the encoder and decoder adaptively disable the GPM coding tool according to a block size. The encoder or decoder of some embodiments turns off the GPM coding tool for any partition or sub-partition having a size greater than or equal to a threshold size. The partition or sub-partition is a block partitioned from a CTB or a CTU to be tested by various coding modes in the RDO stage, and is referred to as a Coding Block (CB) or a Coding Unit (CU) when the partition or sub-partition is selected in the RDO stage. For example, the threshold size is 2048 samples, so in the RDO stage, the PE group processing 64×64 partition, 64×32 sub-partitions, and 32×64 sub-partitions skips evaluating the GPM coding tool on the 64×64 partitions, 64×32 sub-partitions, and 32×64 sub-partitions. In some embodiments, the encoder or decoder disables GPM for any block having a size greater than NxN samples, for example, N is 32 or 16. In some other embodiments, the GPM coding tool is adaptively disabled according to a Merge candidate list. Specifically, the encoder turns off the GPM coding tool for any block with a number of Merge candidates in the Merge candidate list larger than a threshold number according to some embodiments of the present invention. For example, the GPM coding tool is only enabled for blocks having a Merge candidate list with only 2 or 3 candidates, while the GPM coding tool is disabled for blocks having a Merge candidate with 4 or more candidates. The corresponding video decoder also disallows decoding a block having Merge candidates more than the threshold number using a GPM mode. In one embodiment, the encoder or decoder adaptively disables GPM according to both a block size and a number of candidates in a Merge candidate list. For example, the encoder or decoder enables GPM for large blocks only if there is a few candidates in the Merge candidate list, otherwise the encoder or decoder disables GPM for large blocks having a lot of candidates. To encode or decode a current block by GPM, the current block includes a first part, a second part, and a third part. The first part of the current block is inter-predicted by a first set of predictors, and the second part of the current block is inter-predicted by a second set of predictors. The first or second set of predictors is derived using its own motion information such as the motion vector and reference index. The third part of the current block is inter-predicted based on a third set of predictors, where the third set of predictors are derived by blending based on the first set of predictors and the second set of predictors.

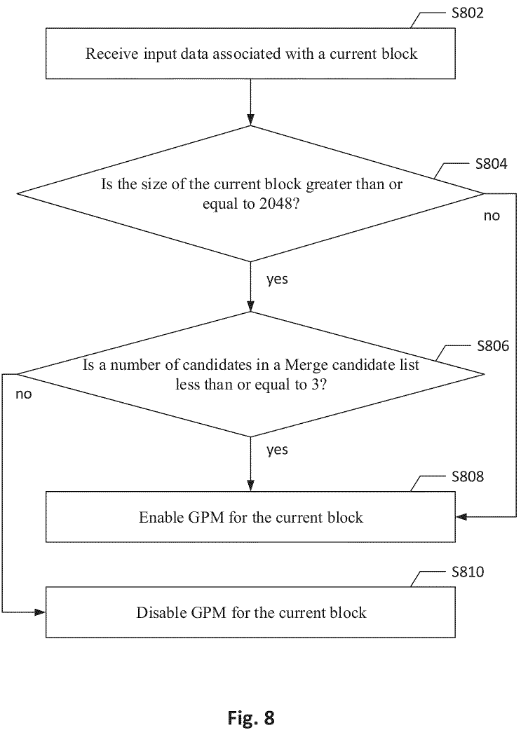

FIG. 8 is a flowchart illustrating an embodiment of adaptively disabling of GPM according to both a block size and a number of Merge candidates. An encoder or a decoder receives input data associated with a current block in step S802, and compares a size of the current block with a threshold size to check if the size of the current block is greater than or equal to 2048 samples in step S804. For example, the current block has a size greater than or equal to 2048 samples when the size is 64×64, 64×32, or 32×64 samples. In cases when the size of the current block is greater than or equal to 2048 samples, the encoder or decoder further compares a number of candidates in a Merge candidate list with a threshold number to check if the number of candidates is less than or equal to 3 in step S806. The encoder or decoder enables GPM for encoding or decoding the current block in step S808 when the size of the current block is smaller than 2048 samples. If the size of the current block is larger than or equal to 2048 samples in step S804 and the number of candidates in the Merge candidate list is less than or equal to 3 in step S806, the encoder or decoder still enables GPM for encoding or decoding the current block; otherwise GPM is disabled in step S810 if the size of the current block is larger than or equal to 2048 samples in step S804 and the number of candidates is larger than 3 in step S806.

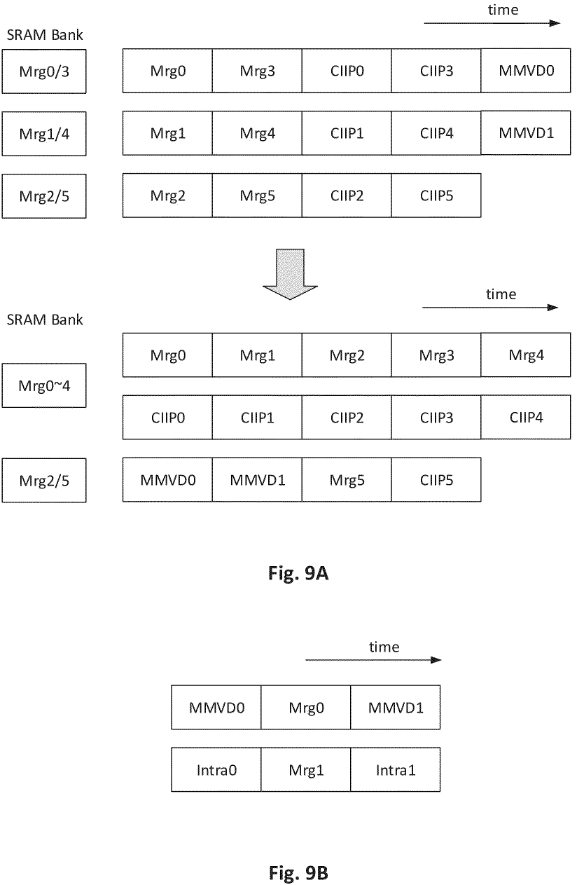

Reordered PE Modes for Minimizing SRAM Bandwidth In some embodiments of the present invention, the coding tools or coding modes is reordered to minimize the SRAM bandwidth. The SRAM bandwidth is further reduced by properly reordering the processing modes. FIG. 9A illustrates an embodiment of reordering coding modes in parallel processing PE to reduce the number of SRAM banks from three to two. Originally, one SRAM bank for a first PE stores search range reference samples for Merge candidate 0 and Merge candidate 3, one SRAM bank for a second PE stores search range reference samples for Merge candidate 1 and Merge candidate 4, and one SRAM bank for a third PE stores search range reference samples for Merge 2 and Merge 5. By reordering the coding modes processed by these three PEs, only two SRAM banks are needed. One SRAM bank stores search range reference samples for Merge candidates 0 to 4, and another SRAM bank stores search range reference samples for Merge candidate 5. The first PE tests Merge candidate 0 in parallel with the second PE which tests CIIP candidate 0. Similarly, the first PE tests a Merge candidate 1 to 4 in parallel with the second PE which tests a corresponding CIIP candidate 1 to 4.

In some other embodiments of PE mode reordering, high-bandwidth modes are reordered to be processed together with low-bandwidth modes in order to balance the bandwidth required for accessing search range reference samples from the SRM. PEs used to compute low-bandwidth modes such as intra modes do not need to access motion compensation reference samples. FIG. 9B illustrates another embodiment of reordering coding modes in parallel processing PEs. A larger bandwidth for accessing reference samples is needed to test the MMVD coding tool comparing to other coding tools, so a PE testing a current partition by a MMVD candidate is processed in parallel with a PE testing the current partition by an intra mode. In FIG. 9B, the first MMVD candidate MMVD-0 is tested by a first PE in parallel with a first intra mode Intra-0 tested by a second PE in a first PE run. In a second PE run, the first Merge candidate Mrg0 is tested by the first PE in parallel with the second Merge candidate Mrg1 tested by the second PE. The second MMVD candidate MMVD-1 is tested by the first PE in parallel with a second intra mode Intra-1 tested by the second PE in a third PE run.

Spatial Shattered SRAM Access for High-Depth BT/TT Splitting PE groups processing high-depth Binary-Tree (BT) or Ternary-Tree (TT) splitting nodes are the bottleneck of search range memory accessing as the numbers of parallel PEs in these PE groups are larger than other PE groups. For example, the PE group TPE-B in FIG. 4 corresponding to high-depth BT/TT splitting nodes has 22 parallel PEs while the PE group LPE corresponding to low-depth BT/TT splitting nodes only has 5 parallel PEs. For processing these small partitions by many parallel PE threads in a high-throughput encoder, the access data for each PE is very minor, and it is very difficult to do multi-accessing. The bandwidth for accessing the search range memory in the high-throughput encoder is normally high, which means one big window can be fetched per cycle. However, the data amount for each PE processing the small partitions such as 8×8 and 8×4 is usually very low, causing a huge waste on the bandwidth for accessing the search range memory. FIG. 10A demonstrates an example of wasting a lot of bandwidth for PEs processing small partitions. The dashed rectangle 1022 inside the SRM 102 illustrates the amount of reference samples that can be fetched at each cycle. A PE processing a small partition 106 only requires a small amount of reference samples 104 as shown in FIG. 10A. A lot of bandwidth is thus wasted as the window 1022 available for accessing the SRM 102 is much larger than the window 104 needed for the PE 106. In some embodiments of the present invention, multiple motion compensation reference regions for multiple candidates are loaded at the same time if the left-top 8×8 motion compensation reference regions fetched by different PEs can be included in the window. In cases when any of the motion compensation reference regions is not in the same window, it can be loaded at the same time if the rotated-index is in the same window. FIG. 10B illustrates an example of spatial shattered SRAM access for high-depth BT/TT splitting nodes. Each candidate corresponds to a reference region having 16×16 samples, and 8×8 samples can be loaded in each fetch cycle, therefore it requires 4 cycles to fetch the entire motion compensation reference region from the SRM. Originally, only motion compensation reference regions of 4 candidates can be loaded in 4 cycles (i.e. 4× 8×8). According to some embodiments of the present invention, motion compensation reference regions of 7 candidates can be parallel loaded in 4 cycles by spatial shattered SRAM accessing. In some embodiments of spatial shattered SRAM accessing, a modulated position of each small partition is calculated by pos_x%window_w, pos_y%window_y. The SRAM banks are rotated for window_w and window_y. If the modulated positions are not collided, one window can fetch multiple small-blocks at the same time. If some of the modulated positions are collided, the motion compensation reference region of one or more small partitions is given up according to an embodiment, or reverse-scan is used for the collided partitions according to another embodiment.

Reduce MMVD Bandwidth for LC The usage range of MMVD for various MMVD distance indices is shown in Table 2. In some embodiments of the present invention, the MMVD Low Complexity (LC) bandwidth can be largely reduced by applying a bilinear filter in the LC operation. FIG. 11 demonstrates an example of reducing the size of a motion compensation reference region for a MMVD candidate and filling the reference region by padding according to an embodiment. An original motion compensation reference region 1104 in a reference picture 1102 is required by a current MMVD candidate, and this region can be reduced to a reduced reference region 1106 by a bilinear filter. The part of reduced reference region 1106 outsides the reference picture 1102 is determined by padding. In one embodiment, an 8-tap bilinear filter is employed for candidates near the center while a 2-tap bilinear filter is employed for candidates far from the center.

TABLE 2

| mmvd_distance_idx[x0][y0] | MmvdDistance[x0][y0] when pic_fpelmmvd _enable _flag==0 | MmvdDistance[x0][y0] when pic_fpel_mmvd_enable_flag== 1 |
|---|---|---|
| 0 | 1 | 4 |
| 1 | 2 | 8 |
| 2 | 4 | 16 |
| 3 | 8 | 32 |
| 4 | 16 | 64 |
| 5 | 32 | 128 |
| 6 | 64 | 256 |
| 7 | 128 | 512 |

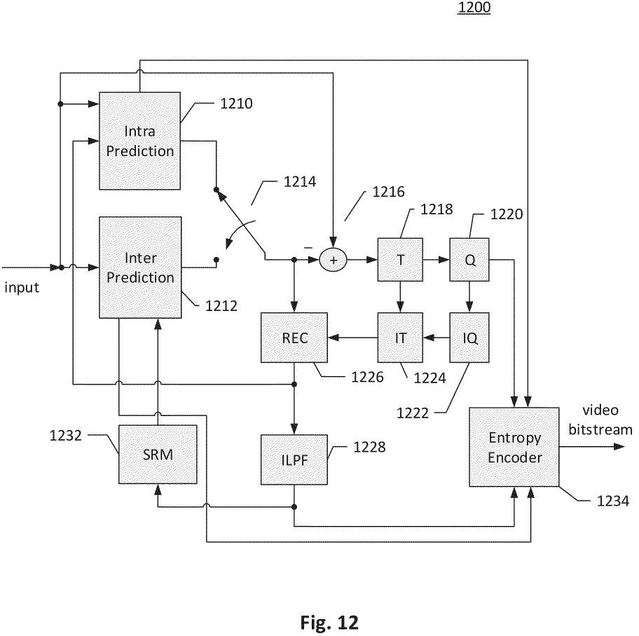

Exemplary Video Encoder and Video Decoder Implementing Present Invention Embodiments of the present invention may be implemented in video encoders. For example, one or a combination of the disclosed methods may be implemented in an entropy encoding module, an Inter, Intra, or prediction module, and/or a transform module in a video encoder. Alternatively, any of the disclosed methods may be implemented as a circuit coupled to the entropy encoding module, the Inter, Intra, or prediction module, and the transform module of the video encoder, so as to provide the information needed by any of the modules. FIG. 12 illustrates an exemplary system block diagram for a Video Encoder 1200 implementing one or more of the various embodiments of the present invention. The video Encoder 1200 receives input video data of a current picture composed of multiple CTUs. Each CTU consists of one CTB of luma samples together with one or more corresponding CTB of chroma samples. Each CTB is processed by parallel PEs in a RDO stage. The PEs process each CTB in parallel to test various coding modes on various partitions of the CTB. In one embodiment, PEs are grouped into PE groups and each PE group is associated with a particular block size. PEs in each PE group compute rate-distortion costs of applying various coding modes on partitions with the particular block size and corresponding sub-partitions. A best block partitioning structure for splitting the CTB into coding blocks and a best coding mode for each coding block are determined according to a lowest combined rate-distortion cost. To test various coding modes, the PEs access a SRM to fetch reference samples, where all or partial of the PEs receive search range reference samples by broadcasting. In some embodiments, GPM is disabled for a current block when a size of the current block is greater than or equal to a threshold size. In a specific embodiment, a number of candidates in a Merge candidate list is also considered, and GPM is enabled for large coding blocks only if the number of candidates is less than or equal to a threshold number. In FIG. 12, an Intra Prediction module 1210 provides intra predictors based on reconstructed video data of the current picture. An Inter Prediction module 1212 performs Motion Estimation (ME) and Motion Compensation (MC) to provide inter predictors based on referencing video data from other picture or pictures. Either the Intra Prediction module 1210 or Inter Prediction module 1212 supplies a selected predictor of a current coding block in the current picture using a switch 1214 to an Adder 1216 to form residual by subtracting the selected predictor from original video data of the current coding block. The residual of the current coding block are further processed by a Transformation module (T) 1218 followed by a Quantization module (Q) 1220. The transformed and quantized residual is then encoded by Entropy Encoder 1234 to form a video bitstream. The transformed and quantized residual of the current block is also processed by an Inverse Quantization module (IQ) 1222 and an Inverse Transformation module (IT) 1224 to recover the prediction residual. As shown in FIG. 12, the residual is recovered by adding back to the selected predictor at a Reconstruction module (REC) 1226 to produce reconstructed video data. The reconstructed video data may be stored in a Search Range Memory (SRM) 1232 and used for prediction of other pictures. The reconstructed video data from the REC 1226 may be subject to various impairments due to the encoding processing, consequently, at least one In-loop Processing Filter (ILPF) 1228 is conditionally applied to the luma and chroma components of the reconstructed video data before storing in the SRM 1232 to further enhance picture quality. A deblocking filter is an example of the ILPF 1228. Syntax elements are provided to an Entropy Encoder 1234 for incorporation into the video bitstream.

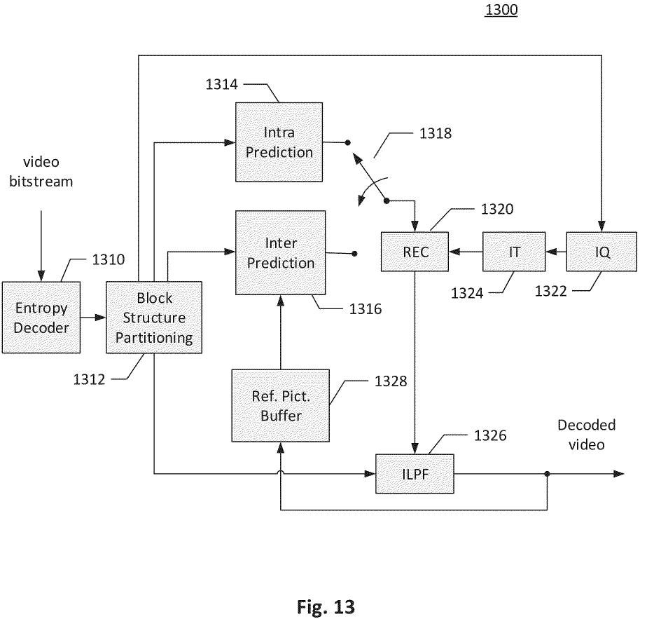

A corresponding Video Decoder 1300 for decoding the video bitstream generated by the Video Encoder 1200 of FIG. 12 is shown in FIG. 13. The input to the Video Decoder 1300 is decoded by an Entropy Decoder 1310 to parse and recover transform coefficient levels of each transform block and other system information. The decoding process of the Decoder 1300 is similar to the reconstruction loop at the Encoder 1200, except the Decoder 1300 only requires motion compensation prediction in an Inter Prediction module 1316. Each leaf block in the video picture is decoded by either an Intra Prediction module 1314 or Inter Prediction module 1316, and a Switch 1318 selects an Intra predictor or Inter predictor according to decoded mode information. In an embodiment of the present invention, GPM is disabled for any block with a size greater than or equal to a threshold size. In some embodiments, if the block size is greater than or equal to a threshold size, at least one of GPM-related syntax elements can be skipped without being parsed. The transform coefficient levels associated with a current transform block are recovered by an Inverse Quantization (IQ) module 1322 and an Inverse Transform (IT) module 1324. The recovered residues are reconstructed by adding back the predictor in a Reconstruction (REC) module 1320 to produce reconstructed video. The reconstructed video is further processed by an In-loop Processing Filter (ILPF) 1326 to generate final decoded video. If a currently decoded video picture is a reference picture, the reconstructed video of the currently decoded video picture is also stored in a Reference Picture Buffer 1328 for later pictures in decoding order.

Various components of the Video Encoder 1200 and Video Decoder 1300 in FIG. 12 and FIG. 13 may be implemented by hardware components, one or more processors configured to execute program instructions stored in a memory, or a combination of hardware and processor. For example, a processor executes program instructions to control whether GPM is enabled or disabled for a current block. The processor is equipped with a single or multiple processing cores. In some examples, the processor executes program instructions to perform functions in some components in the Encoder 1200 and Decoder 1300, and the memory electrically coupled with the processor is used to store the program instructions, information corresponding to the reconstructed images of blocks, and/or intermediate data during the encoding or decoding process. In some examples, the Video Encoder 1200 may signal information by including one or more syntax elements in a video bitstream, and a corresponding video decoder derives such information by parsing and decoding the one or more syntax elements. The SRM in some embodiments is a Static Random Access Memory (SRAM), or the SRM may be implemented by a non-transitory computer readable medium, such as a semiconductor or solid-state memory, a Random Access Memory (RAM), a Read-Only Memory (ROM), a hard disk, an optical disk, or other suitable storage medium. The memory buffer may also be a combination of two or more of the non-transitory computer readable mediums listed above. As shown in FIGS. 12 and 13, the Encoder 1200 and Decoder 1300 may be implemented in the same electronic device, so various functional components of the Encoder 1200 and Decoder 1300 may be shared or reused if implemented in the same electronic device. Any of the embodiments of the present invention may be implemented in the Entropy Encoder 1234 of the Encoder 1200, and/or the Entropy Decoder 1310 of the Decoder 1300. Alternatively, any of the embodiments may be implemented as a circuit coupled to the Entropy Encoder 1234 of the Encoder 1200 and/or the Entropy Decoder 1310 of the Decoder 1300, so as to provide the information needed by the Entropy Encoder 1234 or the Entropy Decoder 1310 respectively.

Embodiments of the video coding methods may be implemented in a circuit integrated into a video compression chip or program code integrated into video compression software to perform the processing described above. For examples, encoding or decoding coding blocks may be realized in program code to be executed on a computer processor, a Digital Signal Processor (DSP), a microprocessor, or Field Programmable Gate Array (FPGA). These processors can be configured to perform particular tasks according to the invention, by executing machine-readable software code or firmware code that defines the particular methods embodied by the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A video coding method in a video encoding system or a video decoding system, comprising:
receiving input data associated with a current block;
comparing a size of the current block with a threshold size;
determining a coding mode for the current block, wherein Geometric Partitioning Mode (GPM) is disabled for the current block when the size of the current block is greater than or equal to the threshold size; and
encoding or decoding the current block by the determined coding mode, wherein the current block comprises a first part, a second part and a third part when the coding mode is GPM, the first part of the current block is inter-predicted based on a first set of predictors, the second part of the current block is inter-predicted based on a second set of predictors, and the third part is inter-predicted based on a third set of predictors, wherein the third set of predictors are derived by blending based on the first set of predictors and the second set of predictors.

2. The method of claim 1, wherein the threshold size is 2048 samples.

3. The method of claim 2, wherein GPM is disabled for the current block when the size of the current block is 64×64, 64×32, or 32×64 samples.

4. The method of claim 1, further comprises determining a number of candidates in a Merge candidate list of the current block, comparing the number of candidates in the Merge candidate list of the current block with a threshold number, and disabling GPM for the current block when the number of candidates is larger than the threshold number.

5. The method of claim 4, wherein GPM is enabled for the current block when the size of the current block is smaller than the threshold size or when the size of the current block is larger than or equal to the threshold size and the number of candidates in the Merge candidate list is less than or equal to the threshold number.

6. The method of claim 4, wherein the threshold number is 3.

7. A video encoding method of determining a block partitioning structure and coding modes by parallel Processing Elements (PEs) in a video encoding system, comprising:
receiving an input data associated with a current block;
processing the input data associated with the current block by the parallel PEs to determine the block partitioning structure of the current block and a coding mode for each coding block in the current block, wherein each PE performs tasks associated with a coding mode or one or more candidates of a coding mode in one or more PE runs, comprising:
accessing a Search Range Memory (SRM) to fetch search range reference samples for the PEs, wherein two or more PEs receive search range reference samples in a broadcasting form;
testing a plurality of coding modes on partitions and sub-partitions of the current block by the PEs;
deciding the block partitioning structure for splitting the current block into one or more coding blocks and a corresponding coding mode for each coding block according to rate-distortion costs associated with the coding modes tested by the PEs; and
encoding each coding block in the current block according to the corresponding coding mode.

8. The method of claim 7, wherein the SRM is a 3-layer SRM structure including a layer 3 SRM, a plurality of layer 2 SRMs, and at least one broadcast SRM, wherein the search range reference samples are output from the layer 3 SRM to the layer 2 SRMs by time interleaving reading for distributing the search range reference samples to corresponding PEs, at least one layer 2 SRM outputs the search range reference samples to the at least one broadcast SRM, and each broadcast SRM broadcasts the search range reference samples to two or more PEs.

9. The method of claim 8, wherein a layer 3 cache port is shared by two or more layer 2 SRMs.

10. The method of claim 8, wherein a scanning order of each broadcast SRM is the same as a scanning order of the corresponding two or more PEs, and the broadcast SRM is a plug-in design in the 3-layer SRM structure.

11. The method of claim 7, wherein the search range reference samples for a regular Merge candidate are broadcasted to the PE testing the regular Merge candidate, the PE testing a Geometric Partitioning Mode (GPM) candidate, and the PE testing a Combined Inter and Intra Prediction (CIIP) candidate.

12. The method of claim 7, wherein the search range reference samples for an Advanced Motion Vector Prediction (AMVP) candidate are broadcasted to the PE testing the AMVP candidate and the PE testing a Symmetric Motion Vector Difference (SMVD) candidate.

13. The method of claim 7, wherein the search range reference samples for an Adaptive Motion Vector Resolution (AMVR) candidate are broadcasted to the PE testing the AMVR candidate, the PE testing a Symmetric Motion Vector Difference (SMVD) candidate, and the PE testing a Bi-prediction with CU-level Weight (BCW) candidate.

14. The method of claim 7, wherein a scan order for the two or more PEs receiving the broadcasting search range reference samples is the same, and the broadcasting search range reference samples are directly used by the two or more PEs without buffering.

15. The method of claim 7, wherein processing the input data by parallel PE further comprises preloading search range reference samples of pre-loadable candidates from the SRM in a current PE run, wherein the search range reference samples of pre-loadable candidates are needed in a subsequent PE run.

16. The method of claim 15, wherein the pre-loadable candidates include one or a combination of Advanced Motion Vector Prediction (AMVP) candidates, Adaptive Motion Vector Resolution (AMVR) candidates, and affine inter based candidates.

17. The method of claim 7, wherein processing the input data by parallel PEs further comprises reordering the coding modes tested by some of the PEs, wherein one or more high-bandwidth modes are reordered to be processed in parallel with one or more low-bandwidth modes.

18. The method of claim 17, wherein the high-bandwidth modes include Merge mode with Motion Vector Difference (MMVD) and the low-bandwidth modes include intra modes.

19. The method of claim 7, wherein at least one PE processing small coding blocks loads the search range reference samples of a plurality of candidates from the SRM at the same time when the search range reference samples are in a same window or when a rotated-index is in a same window.

20. The method of claim 7, wherein one of the plurality of coding modes is Merge mode with Motion Vector Difference (MMVD), and a bilinear filter is used in a Low Complexity (LC) operation for testing one or more MMVD candidates to reduce a reference region of the search range reference samples.

21. An apparatus adaptively enabling Geometric Partitioning Mode (GPM) in a video encoding system or video decoding system, the apparatus comprising one or more electronic circuits configured for:
receiving input data associated with a current block;
comparing a size of the current block with a threshold size;
determining a coding mode for the current block, wherein Geometric Partitioning Mode (GPM) is disabled for the current block when the size of the current block is greater than or equal to the threshold size; and
encoding or decoding the current block by the determined coding mode, wherein the current block comprises a first part, a second part and a third part when the coding mode is GPM, the first part of the current block is inter-predicted based on a first set of predictors, the second part of the current block is inter-predicted based on a second set of predictors, and the third part is inter-predicted based on a third set of predictors, wherein the third set of predictors are derived by blending based on the first set of predictors and the second set of predictors.
